(19) United States
(12) Patent Application Publication
(10) Pub. No.: US 2015/0026034 A1
(43) Pub. Date: Jan. 22, 2015

(54) Financial Systems and Methods for Increasing Capital Availability by Decreasing Lending Risk

(71) Applicant: Credibility Corp., Malibu, CA (US)

(72) Inventor: Jeffrey M. Stibel, Malibu, CA (US)

(73) Assignee: Credibility Corp., Malibu, CA (US)

(21) Appl. No.: 14/155,158

(22) Filed: Jan. 14, 2014

Related U.S. Application Data
(60) Provisional application No. 61/847,667, filed on Jul. 18, 2013.

(51) Int. Cl. G06Q 40/02

(52) U.S. Cl. CPC G06Q 40/025
USPC 705/38

(57) ABSTRACT

Some embodiments provide a guarantor system for backstopping all or a substantial portion of a lender's portfolio of loans with an insurance guarantee. The guarantor system builds the insurance guarantee into the covered portion of the lender's portfolio in an integrated manner, whereby the overhead cost for insuring the loans of the portfolio is distributed across the portfolio instead of being distributed individually to each borrower based on the individual borrower's risk profile. Some embodiments also provide various monitoring services to reduce lender risk. These include contacting the borrower to remind the borrower of upcoming payments that are due, conducting a quasi-audit of the borrowers to inform the lenders of a potential risk of default, and establishing a credit profile for the borrower using the information collected as part of the quasi-audit.

### CLAIM OF BENEFIT TO RELATED APPLICATIONS

This application claims the benefit of U.S. provisional application 61/847,667 entitled “Financial Systems and Methods for Increasing Capital Availability by Decreasing Lending Risk”, filed Jul. 18, 2013. The contents of application 61/847,667 are hereby incorporated by reference.

### TECHNICAL FIELD

The present invention pertains to financing and more specifically, to the lending of capital.

### BACKGROUND

Many small businesses and new businesses have difficulty in obtaining the capital they need to conduct business and grow. Lenders restrict the amount of capital that they lend to small or new businesses because of the scarce information on these businesses. Specifically, lenders use information, such as payment history and credit history, to assess the risk that is associated with lending to these businesses. When such information is not available or recorded for a small or new business, lenders cannot ascertain how risky it is to lend to the business and will therefore restrict how much, if any, capital they lend to such businesses.

To offset some of the lending risk, small businesses or new businesses are typically required to either offer some form of collateral or personal guarantee to back the loan or provide some form of private insurance to insure the loan debt in the event of the borrower's default. Each of these options imposes additional cost and overhead on the borrower with the entirety of the cost being imposed on the individual borrower.

The process of backstopping a loan with collateral, a personal guarantee, or private insurance also creates an additional layer of complexity in the lending process. Specifically, the borrower goes through a first process to apply and qualify for a loan from a lender. The borrower then goes through a second independent process to obtain private insurance for the loan from a third-party or to qualify and receive acceptance of the collateral or personal guarantee for backstopping the loan.

For these reasons, the overhead (i.e., time and cost) to acquire capital is higher for the small or new business than it is for a large or well-established business. Accordingly, there is a need to provide small businesses and new businesses greater and equivalent access to capital, and to do so, without them having to fully bear the cost of backing the capital with collateral, personal guarantees, or private insurance. There is further a need to simplify the process that small and new businesses go through in order to acquire the capital they need. Stated differently, there is a need to eliminate the need to apply for a loan from a lender and then separately apply for private insurance or separately qualify collateral or a personal guarantee to back the loan.

### SUMMARY OF THE INVENTION

It is an objective of the present invention to lower the risk that lenders face when lending to small businesses and new businesses. It is further an objective to do so by offsetting the cost for the risk reduction uniformly across the lender's portfolio, rather than on a per loan or per borrower basis. It is further an objective to provide the risk reduction in a manner that simplifies the lending process. In so doing, it is an objective to provide small businesses and new businesses greater access to capital without the cost and complexity associated with the borrower backstopping a loan with collateral, personal guarantees, or third-party insurance.

To achieve these and other objectives, some embodiments provide a guarantor system for backstopping all or a substantial portion of a lender's portfolio of loans with an insurance guarantee. The guarantor system builds the insurance guarantee into the covered portion of the lender's portfolio in an integrated manner, whereby the overhead cost for insuring the loans of the portfolio is distributed across the portfolio instead of being distributed individually to each borrower. The guarantor system determines the premium for the insurance guarantee based on the total risk associated with all loans within the covered portfolio rather than on each individual borrower's risk profile. Moreover, by building the insurance guarantee into the lender's portfolio, the guarantor system eliminates the need for a supplemental or a secondary application process by which the borrower qualifies collateral, a personal guarantee, or private insurance to backstop the loan. As a result, the lender is able to coordinate the entire process of lending to a borrower and the borrower can obtain a loan directly from the lender without secondary considerations. The insurance guarantee has the benefit of lowering the lender's overall risk exposure. Consequently, the lender can rebalance its overall risk exposure by increasing the capital it makes available to small or new businesses.

To provide the insurance coverage for the lender's portfolio of loans, the guarantor system performs a risk assessment of the lender. As part of the risk assessment, the guarantor system analyzes the lender's lending practices to measure the lender's overall risk exposure. The guarantor system then generates an insurance policy to cover the loans within the lender's portfolio with the amount of coverage, the premium, and other terms of the insurance policy being computed based on the risk assessment of the lender. In some embodiments, the provided policy insures all or a substantial number of loans in the lender portfolio against borrower default for some percentage of the loan amount and/or for some duration of the loan term. The insurance coverage may insure existing loans, new loans, or some combination thereof.

Some embodiments build the premium cost for the insurance policy into each administered loan. The cost can be incorporated as increased interest rates, lending points, or a surcharge directly invoiced to the borrower. The same cost is levied on all borrowers in the portfolio including high risk and low risk borrowers alike. As such, the per-unit cost is reduced, because the insurance premium is determined according to the risk associated with the overall lender portfolio as opposed to being a determination of the risk associated with an individual borrower.

In some embodiments, the insurance policy and the associated fee premium can be provided on a graduated scale. In some such embodiments, the policy protects the lender for some initial payback amount or for some payback period and the insurance policy is removed after the initial payback amount is made or the payback period ends. This shields the lender from the increased risk of lending to small businesses and new businesses that have unproven payment histories and require the insured term to establish such a history with the lender. During this insured term, the borrower can also establish a relationship with the lender and provide greater insight into the borrower's business (e.g., assets, revenue, growth, etc.) such that the lender can conduct a more complete risk assessment of the borrower at the end of the insured term. The lender can then determine whether to continue lending to that borrower or whether to change terms of the original loan.

To further mitigate the lender's risk exposure and thereby increase the lender's willingness to lend to small or new businesses, some embodiments of the guarantor system provide various monitoring services. As part of the monitoring service of some embodiments, the guarantor system contacts the borrower on behalf of the lender. In some embodiments, the contact provides the borrower with reminders for upcoming payments due to the lender. These reminders avoid issues relating to lost or misplaced invoices and also refocus the borrower on the payment that is due.

As part of the monitoring service of some embodiments, the guarantor system contacts the borrower or trade references of the borrower in order to conduct a quasi-audit of the borrower. The quasi-audit collects information about the borrower. The collected information can then be used to determine whether the borrower is likely to continue paying on-time or whether the borrower is at risk of future default. The quasi-audit can collect information such as whether the borrower has timely submitted payments that are due to its trade references, whether the borrower has experienced a growth or decline in sales, and whether the borrower has timely submitted payments on a loan guaranteed by the guarantor system.

In some embodiments, the guarantor system uses the collected information to automatically and more expediently establish a credit profile for the borrower. By establishing the credit profile on behalf of a new or small business, the guarantor system enables lenders to more accurately assess the risk profile of such a business, thereby making capital acquisition in the future easier for the business provided that the business has fulfilled its payment obligations on-time.

In some embodiments, the information that the guarantor system collects on the borrowers as part of the monitoring service is resold to various credit reporting agencies. Credit reporting agencies value accurate payment history, trade reference, and other payment or risk related information, especially when the information is on difficult targets such as new and small businesses. In some embodiments, the guarantor system resells the collected information to the credit reporting agencies in order to offset or reduce the insurance premium charged to lenders and/or borrowers, thereby making the insurance coverage more affordable for lenders and borrowers alike. The guarantor system thus proves advantageous to all involved parties including borrowers that benefit from being able to more easily obtain the capital they need, lenders that benefit from reduced overall risk exposure, and credit reporting agencies that benefit from obtaining difficult to acquire information on new and small businesses. Moreover, in some embodiments, the guarantor system resells the collected information to different lenders. The collected information allows the lenders to perform a more accurate risk assessment of potential borrowers that are otherwise unknown to the lenders. For example, a first lender may extend a loan to a particular new business for which no prior information exists. The guarantor system monitors the performance of the particular new business under the terms of the loan. Thereafter, when the particular new business applies for a loan from a second lender, the guarantor system may sell the information collected on the particular new business to the second lender, thereby allowing the second lender to make a more informed decision on whether or not to lend to that particular new business.

### BRIEF DESCRIPTION OF THE DRAWINGS

In order to achieve a better understanding of the nature of the present invention, a preferred embodiment of the guarantor system will now be described, by way of example only, with reference to the accompanying drawings in which:

FIG. 1 presents a process performed by the guarantor system for lowering lender risk by insuring all or substantial portion of the lender's portfolio of loans against individual loan default in accordance with some embodiments.

FIG. 2 presents a timeline depicting the life of a loan and the graduated insurance protection provided by the guarantor system during this term.

FIG. 3 presents a process for managing an insurance policy provided by the guarantor system to a lender in accordance with some embodiments.

FIG. 4 presents a process describing the notification reminder monitoring service performed by the guarantor system in accordance with some embodiments.

FIG. 5 presents a process describing the quasi-audit monitoring service of the guarantor system in accordance with some embodiments.

FIG. 6 illustrates leveraging the monitoring service of the guarantor system to resell information about borrowers in a manner that reduces the overall cost of insuring loans that are issued to the borrowers.

FIG. 7 illustrates a computer system with which some embodiments are implemented.

### DETAILED DESCRIPTION OF THE INVENTION

In the following detailed description, numerous details, examples, and embodiments of a guarantor system are set forth and described. As one skilled in the art would understand in light of the present description, the guarantor system is not limited to the embodiments set forth, and may be practiced without some of the specific details and examples discussed. Also, reference is made to the accompanying figures, which illustrate specific embodiments in which the system can be practiced. It is to be understood that other embodiments can be used and structural changes can be made without departing from the scope of the embodiments herein described.

The guarantor system reduces lender risk by backstopping all or a substantial portion of the lender's portfolio of loans with an insurance guarantee. The guarantor system builds the insurance guarantee into the covered portion of the lender's portfolio in an integrated manner, whereby the overhead cost for insuring the loans of the portfolio is distributed across the portfolio instead of being distributed individually to each borrower. In this manner, the guarantor system insures the lender portfolio against individual defaults, thereby reducing the lender's overall risk exposure. The reduced risk allows the lender to offer additional capital in the form of loans to businesses that would otherwise be outside the risk profile that the lender is willing to accept. Some such businesses include small businesses and new businesses that do not have established payment histories or credit profiles and, as a result, are deemed to be high risk. In other words, the lender can rebalance its overall risk exposure by increasing the capital it makes available to small or new businesses to offset the risk reduction provided by the guarantor system. The reduced risk also allows lenders to simplify the lending process by removing the need for a borrower to independently provide collateral, a personal guarantee, or private insurance to backstop the loan.

In some embodiments, the guarantor system performs various monitoring services to remind borrowers of upcoming obligations and to establish or update a borrower's credit profile. As part of the monitoring services, the guarantor system collects information on the borrower's payment history, trade references, etc. over the duration of a loan that is insured by guarantor system. Using the collected information, the guarantor system can perform a quasi-audit of each borrower to determine whether the borrower is likely to continue paying on-time or whether the borrower is at risk of future default. In some embodiments, the guarantor system uses the collected information to automatically and more expediently establish borrower credit profiles to facilitate future lending decisions. In some embodiments, the guarantor system resells the collected information to credit reporting agencies for their respective credit scoring and reporting functions. In some embodiments, the guarantor system resells the collected information to other lenders to allow the lenders to make more informed decisions when determining whether or not to lend to a potential borrower. In some embodiments, the reselling of the collected data offsets or reduces the insurance premium charged to lenders and/or borrowers, thereby making the insurance coverage more affordable for lenders and borrowers alike.

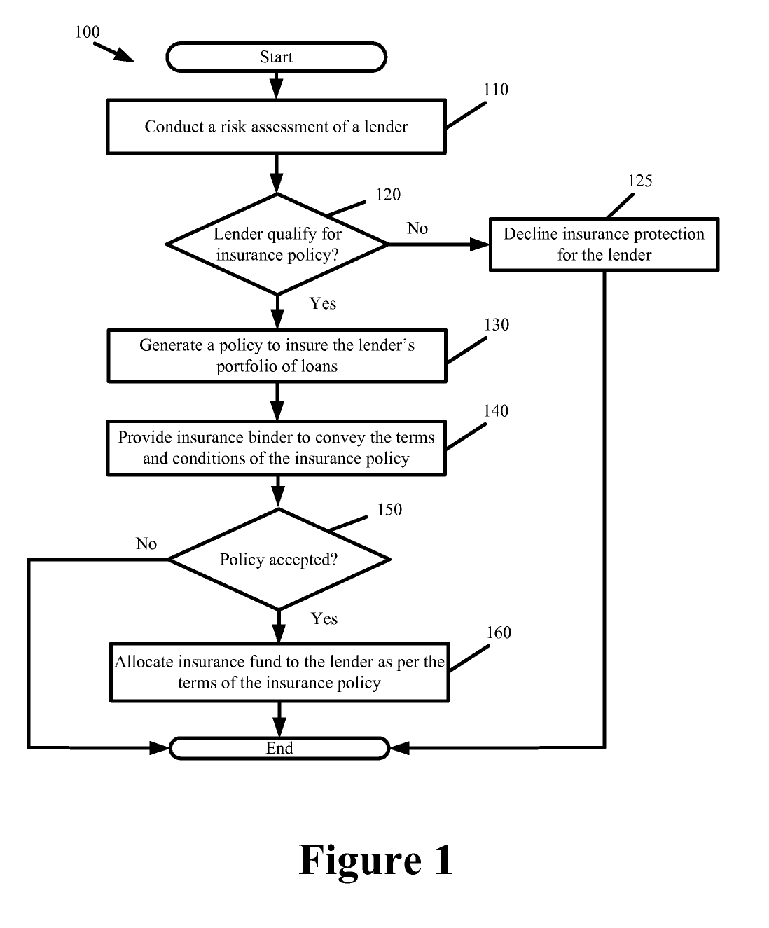

FIG. 1 presents a process performed by the guarantor system for lowering lender risk by insuring all or substantial portion of the lender's portfolio of loans against individual loan default in accordance with some embodiments. The process begins by conducting (at 110) a risk assessment of a lender.

The risk assessment involves analyzing the lending practices and policies of the lender. In some embodiments, the guarantor system analyzes the loan application process of the lender according to the terms of past loans that were originated by the lender, the qualifications of the borrowers for each of those loans, default rate of the past loans, and other criteria used by the lender in determining when to offer a loan and the terms of the loan being offered. For example, the process looks to the average credit score of the borrowers that have acquired loans from the lender in the past year and the average terms of the loans provided to those borrowers. From the risk assessment, the process determines how the lender allocates risk and how much risk the lender takes on in its portfolio. For instance, the process determines from the risk assessment whether (1) the lender exposes itself to too much risk by lending only to high-risk borrowers, (2) the lender has a more risk-averse approach by lending only to low-risk borrowers, or (3) the lender has a mix of high-risk and low-risk borrowers.

It should be noted that the risk assessment described at step 110 of process 100 differs from that of the prior art. First, the disclosed embodiments are directed to assessing the risk of the lender, as opposed to assessing the risk of the individual borrower as is done for Private Mortgage Insurance (PMI) or Small Business Insurance (SBA) programs. Second, the disclosed embodiments perform the risk assessment for the purpose of insuring the lender and, more specifically, the lender's portfolio of loans, as opposed to insuring the individual borrower and, more specifically, the individual borrower's loan.

Based on the lender risk assessment, the process determines (at 120) whether the lender qualifies for the guarantor system's insurance protection. If the risk assessment reveals that the lender's portfolio is too much at risk, the guarantor system declines (at 125) insurance coverage for the lender and the process ends. This may be the case when the lender's portfolio consists only of subprime loans or the lender experiences an above average rate of default on the loans it originates. If the guarantor system determines that the lender's portfolio is not too great of a risk and can be insured, the process generates (at 130) a policy to insure the lender's portfolio.

The guarantor system insurance policy can insure all or a substantial portion of loans in the lender's portfolio. The insurance can apply retroactively to existing loans in the lender's portfolio, new loans originated after the effective date of the insurance policy, or some combination thereof. The terms and premium of the generated insurance policy will reflect the amount of risk being assumed by the guarantor system in insuring the lender's portfolio of loans. For example, if the risk assessment identifies a risk-averse lender that lends primarily to low-risk borrowers, the process provides an insurance policy that insures each loan in the lender's portfolio by a larger percentage at a lower overall premium, whereas if the risk assessment identifies a risk-loving lender that lends primarily to high-risk (e.g., subprime) borrowers, the process provides an insurance policy that insures each loan in the lender's portfolio by a smaller percentage at a higher overall premium.

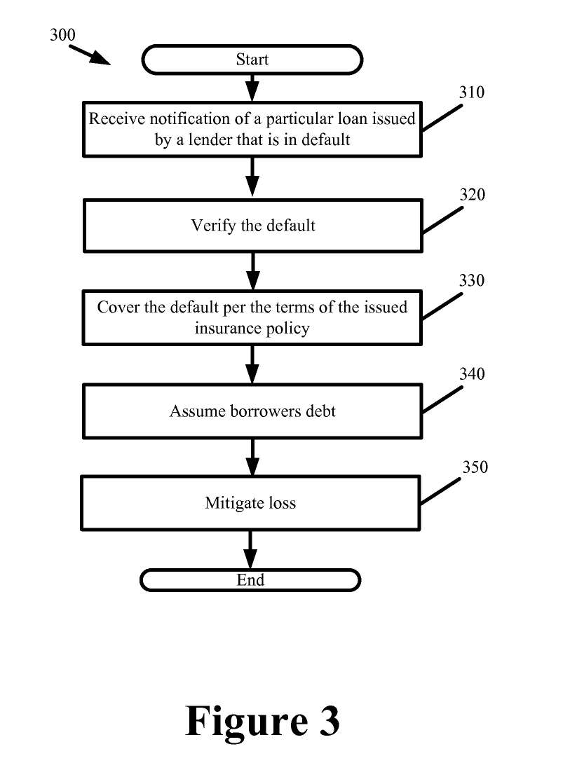

The process provides (at 140) an insurance binder to the lender conveying the terms and conditions of the insurance policy. At this stage, the lender can accept or decline (at 150) the insurance protection. Should the lender decline the insurance protection, the process ends. Should the lender accept the insurance protection, the process allocates (at 160) an insurance fund to the lender as per the terms of the insurance policy. The insurance fund is the amount needed to cover the policy. The insurance fund can be provided by the guarantor system. The insurance fund can also be provided by a third-party insurance provider. In such cases, the guarantor system acts as a broker that insures a lender and then sells the insurance policy to a third party that backstops the loan. Once the policy is issued, the guarantor system monitors claims made against the policy and provides coverage where appropriate according to the terms and conditions of the insurance policy as discussed in FIG. 3 below.

In some embodiments, the offered insurance policy covers some percentage of the total amount for each loan in the lender's portfolio that is covered by the guarantor system insurance policy against that loan's default. It should be noted that in preferred embodiments, the full amount of a loan is not covered. This is for two reasons. First, the insurance fund needed to protect the full amount of all loans in the lender's portfolio would simply be too great of a sum. Second, the partial loan coverage avoids the moral hazard that could be created if the entire amount of each loan was insured. In such cases, the lender would be cleared of all risk and therefore have no incentive to avoid high risk borrowers. However, when only a partial amount of the loan is protected, the lender will continue to be exposed to risk albeit a lowered amount based on the partial coverage against default provided by the insurance policy.

The lender can build the premium for the insurance policy into the loans that it offers to new borrowers. The cost can be recouped by increasing the interest rate for the loans that are offered by the lender. The cost can be recouped as points charged with the issuance of any loan offered by the lender. Lastly, the cost can be recouped as a direct surcharge or fee that the lender charges the borrower. Even though each borrower is charged a uniform premium, the amount of the premium is adjusted based on the size of the borrower's loan. In any case, the added cost to any individual borrower is significantly lower than if the borrower was to obtain similar protection for his own individual loan. This is because the guarantor system distributes the cost for the insurance between all borrowers of a particular lender, thereby realizing the overall risk reduction benefit from insuring a large population. Also, the insurance policy premium, whether assessed on the lender or the individual borrowers, is determined independent of the risk associated with each individual borrower and independent of the risk associated with each individual loan.

An example is now provided to illustrate the uniform premium that the guarantor system assesses on the borrowers of one lender. In the present example, the guarantor system may assess a $10 premium for every $1,000 of a loan. Thus, a first borrower with a $10,000 loan would be assessed a $100 premium, whereas a second borrower with a $20,000 loan would be assessed a $200 premium.

In some embodiments, the offered insurance policy protects each loan for some duration after loan origination. For example, the insurance policy may protect each loan during some initial term of the loan duration. As a specific example, the insurance policy may protect a four-year term loan against default for the first year after loan origination. After the first year, the insurance protection is removed in some embodiments.

The time element reduces the cost for the insurance policy premium as the insurance protection is provided for some duration that is less than the overall duration of the loan. The lender may pass the cost of the insurance premium to the borrower during the covered duration and remove the cost of the insurance premium thereafter. Alternatively, the lender may distribute the cost of the insurance premium over the full duration of the loan such that the increase per payment is less than if the cost of the insurance premium was to be paid back during the effective term of the insurance.

The time element protects the lender during the initial period where the lender is most at risk from borrowers that have not proven their ability to pay back the loan. This is especially true when lending to small or new businesses that do not have an established credit profile or payment history from which the lender can assess the risk for lending to such businesses. After the initial term of the loan, the borrower will have established a payment history and credit profile with the lender, thereby proving to the lender that it can continue to successfully live up to the terms of the loan in the future without the need for the added insurance protection and the increased costs associated therewith. Should the lender identify weakness in the borrower's payment ability once the initial term passes, the lender can adjust the terms of the loan or can require the borrower to provide collateral, a personal guarantee, or other insurance for the remaining term of the loan.

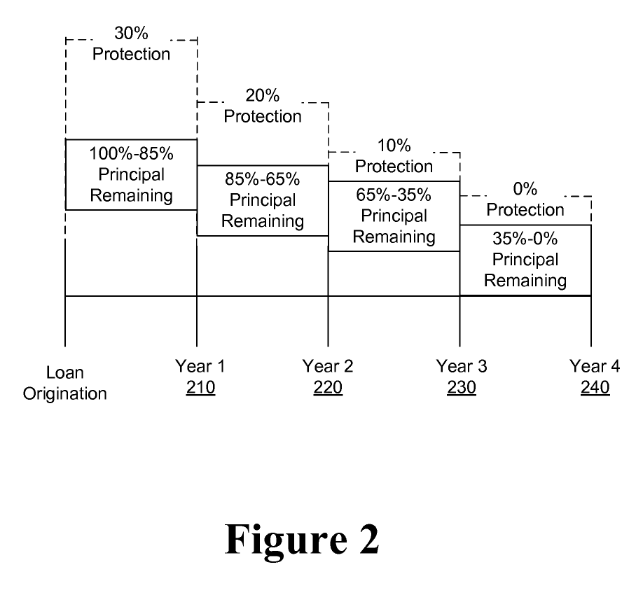

In some embodiments, the guarantor system provides graduated insurance protection for a loan. The graduated protection is depicted in FIG. 2. FIG. 2 presents a timeline depicting the life of a loan and the graduated insurance protection provided by the guarantor system during this term. As shown, for the first year 210 of a four year term, the guarantor system protects 30% of the loan amount; for the second year 220 of the loan, the guarantor system protects 20% of the remaining loan amount; for the third year 230 of the loan, the guarantor system protects 10% of the remaining loan amount; for the fourth year 240 of the loan, the guarantor system does not provide any protection for the remaining loan amount.

The graduated insurance protection reflects the reduction in the lender's risk over the life of the loan. As the loan principal decreases over time, so too does the amount of the loan that is at risk of being defaulted. The reduction of insurance coverage through the graduated plan is intended to mirror the reduced risk through the reduced principal. In other words, by reducing the coverage in proportion to the reduction in the loan principal over the life of the loan, the insurance policy is able to provide an equal level of protection throughout but for the final year (e.g., 20%-30% protection of the outstanding principal throughout the first three years).

It should be noted that the guarantor system and the offered insurance policy differs from prior art offerings in various ways. First, the guarantor system provides a policy to insure the lender, instead of providing a policy that insures each individual borrower. Second, the guarantor system provides a policy to insure the entirety or a substantial portion of the lender's portfolio of loans, instead of providing a policy for individual loans. Third, the lender has full control over the lending process. In the past, the borrower would have to perform a secondary application process of obtaining private insurance for the loan (e.g., PMI, SBA, etc.) or a secondary process of offering and receiving approval for collateral or a personal guarantee to backstop the loan. Now with the backstopping of the entire lender portfolio provided by the guarantor system, the lender is no longer affected by the borrower's ability or inability to provide collateral, provide a personal guarantee, or obtain private insurance to backstop a loan. The insurance is automatically incorporated into every loan. In summary, the guarantor system simplifies the lending process while simultaneously reducing risk with the cost premium for doing so being spread across the entire portfolio as opposed to being isolated solely on the high risk borrowers, such that the per unit cost is significantly reduced.

It should also be noted that backstopping the entire or substantial portion of the lender's portfolio and distributing the cost to all borrowers should not increase the lender's overall risk by dissuading low risk borrowers from the lender while persuading high risk borrowers. First, the lender still has full control over its risk exposure and can decline lending to high risk applicants. Second, the cost of the insurance premium either does not increase or only slightly increases borrower payments such that low risk borrowers will not be dissuaded from borrowing from a lender backed by the guarantor system. As noted above, by distributing the costs of the insurance across the portfolio, by limiting the term of the coverage, and by providing the graduated coverage, the per unit cost for insuring each issued loan is minimal. Furthermore, the lender can offset the added cost for the insurance premium by lowering the interest rate for its loans. Specifically, the interest rate is partly determined to cover an assumption of risk by the lender when lending to a borrower. When this risk is lowered by way of the guarantor system insurance protection, the lender can reduce the interest rate it charges, thereby offsetting any cost increases associated with the insurance premium.

Upon issuing an insurance policy to cover loans of a particular lender's lending portfolio, the guarantor system commences management of that insurance policy. Management includes overseeing the insurance obligation and protecting the lender in the event of a default on a protected loan.

FIG. 3 presents a process 300 for managing an insurance policy provided by the guarantor system to a lender in accordance with some embodiments. The process commences by receiving (at 310) notification of a particular loan issued by the lender that is in default. In some embodiments, the notification comes from the insured (i.e., the lender). The notification usually comes after the borrower has missed one or more payments and the lender has verified that the borrower is unable to cure the default or will not do so.

The process then verifies (at 320) the default. The guarantor system verifies the default to determine whether the default is still covered under the terms of the insurance policy. If so, the guarantor system then verifies the default to ensure that the borrower has been given sufficient opportunity and recourse to cure the default and that the borrower has been unable or unwilling to do so. As part of the default verification, the guarantor system may contact the borrower to accurately assess the financial solvency of the borrower. Additionally, the guarantor system may offer various remedial alternatives to the borrower such as refinancing.

If after verification, the guarantor system determines that the borrower cannot cure the default, the process covers (at 330) the default per the terms of the issued insurance policy. This involves rendering payment to the lender for the covered amount of default. As noted above, the rendered payment covers some percentage of the overall loan less than the full amount in most cases.

The guarantor system then assumes (at 340) either the entirety of the borrower's remaining obligations under the terms of the loan or the amount that was compensated to the lender. The process then attempts to mitigate (at 350) the loss by reselling the acquired debt to a collections agency or by pursuing repayment from the borrower.

In some embodiments, the guarantor system additionally or alternatively reduces lender risk by providing various monitoring services. The lowered risk provided through the monitoring services enables lenders to further increase the amount of capital that they make available to borrowers, especially to higher risk borrowers such as small businesses or new businesses. As with the insurance protection described above, the monitoring service lowers the overall risk of the portfolio, thus allowing lenders to offset that lowered risk by lending to additional high-risk borrowers.

In some embodiments, the guarantor system performs a monitoring service to notify borrowers of upcoming payment due dates. The notifications from the guarantor system supplement the invoices and notifications that are sent from the lender. The guarantor system notifications reduce risk by providing an additional reminder of an upcoming payment that is due in the event that the borrower loses, forgets, or never receives invoices or reminders from the lender.

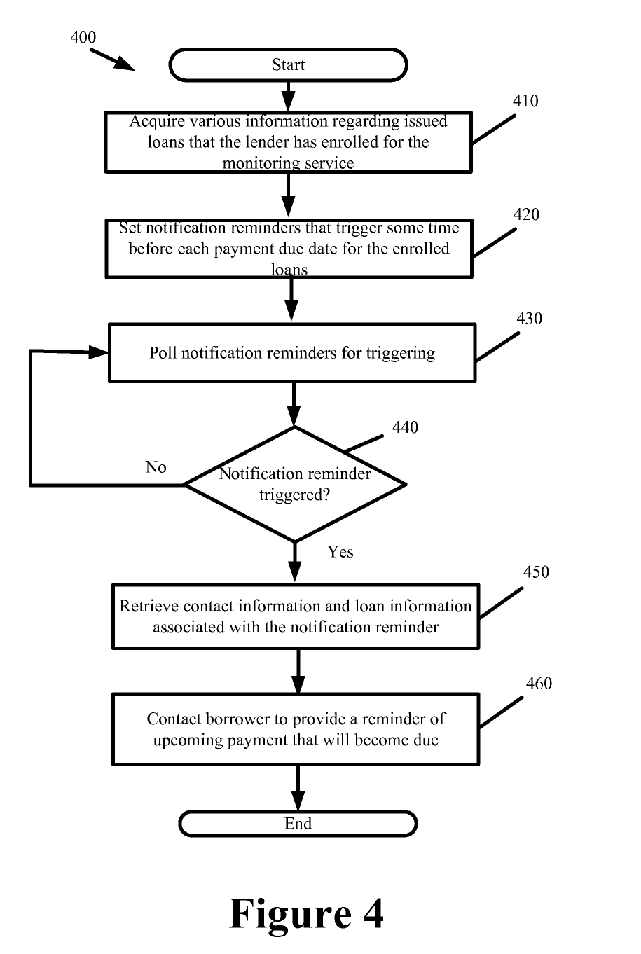

FIG. 4 presents a process 400 describing the notification reminder monitoring service performed by the guarantor system in accordance with some embodiments. To implement the monitoring service, the process coordinates with a lender to acquire (at 410) various information regarding loans that the lender has enrolled for the monitoring service. This information at least includes the name and contact information for a borrower of an enrolled loan and payment due dates for that enrolled loan.

The process sets (at 420) notification reminders that trigger some time before each payment due date for the enrolled loans. The process then polls (at 430) the notification reminders until one is triggered (at 440). When a notification reminder is triggered, the process retrieves (at 450) the contact information and loan information associated with the notification reminder. The process then contacts (at 460) the borrower on behalf of the lender to provide the borrower with a reminder of a payment that is coming due.

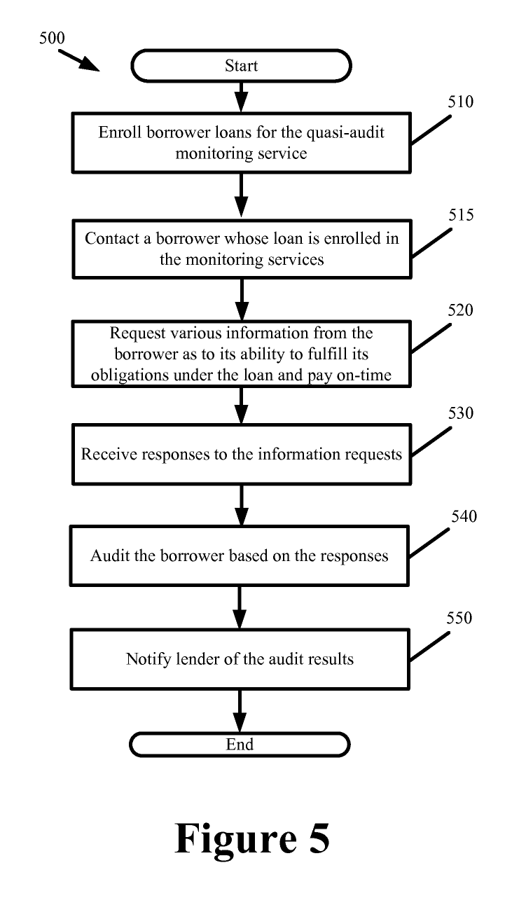

In some embodiments, the guarantor system performs a monitoring service to conduct a quasi-audit of a borrower on behalf of a lender. FIG. 5 presents a process 500 describing the quasi-audit monitoring service of the guarantor system in accordance with some embodiments.

The process 500 commences with a lender enrolling (at 510) one or more borrower loans for the quasi-audit monitoring service. In some embodiments, a borrower can self-enroll for the quasi-audit monitoring service. A borrower may do so to satisfy terms of a loan it acquires or to provide the lender with a periodic performance review. Enrolling a loan involves providing the guarantor system with at least the name and contact information of a borrower that is to be periodically audited. Enrollment may further involve providing the guarantor system with loan information, such as the terms of the loan.

Once a loan is enrolled, the process contacts (at 515) the borrower. The contacts will occur periodically to continue the quasi-audit and obtain updated information. The guarantor system by way of the monitoring service may periodically contact the borrower throughout the duration of a loan that is insured by guarantor system.

When the process has established contact, the process requests (at 520) information about the borrower's ability to meet its debt obligations. Some examples of information obtained to perform the quasi-audit include recent payment history of the borrower, whether the business has hired or fired employees, financial information, debt, revenue, inventory, and copies of invoices or statements as some examples. In general, the requested information is directed to ascertaining the creditworthiness of the borrower.

The information requests can be submitted over one or more different communication mediums. For example, the guarantor system can email the borrower with a questionnaire that the borrower can answer and return. The guarantor system can alternatively place a telephone call to the borrower and receive responses through touch-tone entries or audible recordings. The contact can also be made by a live person who then records the borrower's answers and enters the answers to the guarantor system. Physical mailings, text messaging, and instant messaging are other communication mediums that can be used for the quasi-audit monitoring service.

In some embodiments, the guarantor system contacts and obtains information from the borrower's trade reference in addition to or instead of contacting the borrower. The trade references can verify whether the borrower is meeting its obligations to the trade references and whether the trade references will continue conducting business as is, increase dealings with the borrower, or decrease dealings with borrower. In some embodiments, the guarantor system retrieves information about the borrower from other sources including credit reporting agencies that produce the borrower's credit report and publicly available sources such as the borrower's website and public government databases.

To verify the acquired information, the guarantor system can request invoices, statements, and other documents to evidence the accuracy of the information provided by the borrower, trade references, and other sources. The guarantor system can also verify the information acquired from the borrower by comparing it against information that the guarantor system obtains from the borrower's trade references or other sources (e.g., Internet sites, databases, etc.). If the information matches, it is verified. If the information does not match, the guarantor system can question the borrower as to the discrepancy and the borrower may be provided an opportunity to cure the deficiency.

The process then conducts (at 540) an audit of the borrower using the information it receives from the borrower, trade references, and/or other sources. The audit involves processing the collected information to quantify the borrower's risk of future default. More generally, the audit evaluates whether the borrower's business prospects are improving or worsening, and can therefore be used to gauge the ability of the borrower to meet its payment obligations under the terms of the loan. For instance, if the borrower reports declining revenue throughout the year or missed payments to trade references, then the audit will identify that the borrower has an increased chance to default on its loan. Conversely, upward trending information regarding the creditworthiness of the borrower provides confirmation that the borrower is likely to fulfill its loan obligations, thereby indicating the borrower is at a lowered risk of default. The audit serves as a continued risk assessment of the borrower throughout the duration of a loan.

The process notifies (at 550) the lender of the results of the borrower audit. Based on the audit results, the lender can take preemptive actions to avoid a borrower defaulting. For example, the lender may reach out to the borrower and adjust the terms of the loans temporarily to accommodate the borrower's disposition. In summary, the audit reduces the lender's overall risk by providing insight into a borrower's disposition during the pendency of a loan. This insight can serve as an early warning system that the lender can leverage to avoid some loan defaults.

The periodic information gathering and audit may seem obtrusive and bothersome for the borrower. However, a lender may require a borrower to enroll in this monitoring service as a prerequisite to offering the borrower a loan. This greater insight provided to the lender by the monitoring service allows the lender to better manage risk and thus also serves to lower the risk exposure of the lender.

To offset the burden imposed by the monitoring service on the borrowers, the guarantor system may provide certain benefits to the borrowers in return. The benefits entice the borrowers to provide the information needed for the audit. One such benefit offered by the guarantor system is the automatic establishment and updating of the borrowers' credit profile using the collected information. This improves the likelihood that a borrower can obtain future capital provided that the borrowers have fulfilled their payment obligations for the loans being monitored by the guarantor system. Specifically, the up-to-date credit profile information collected by the monitoring service provides lenders with more insight about the borrowers, thereby reducing the unknowns that lenders face when determining whether or not to lend to such borrowers. This service is especially beneficial to small and new businesses. Many small businesses and new businesses do not have an established payment history and credit profile. As such, small and new businesses are deemed higher risk borrowers because their payment ability is unknown or unproven. For this reason, small and new businesses are routinely denied credit or are offered credit with worse terms than others having an established credit profile from which a credit risk can be ascertained. Accordingly, in some embodiments, the information that the guarantor system collects as part of the monitoring service is passed from the guarantor system to various credit reporting agencies that maintain their own credit profiles on the borrowers monitored by the guarantor system. The credit reporting agency use the collected information to update the credit profile for the corresponding borrower to which the information relates.

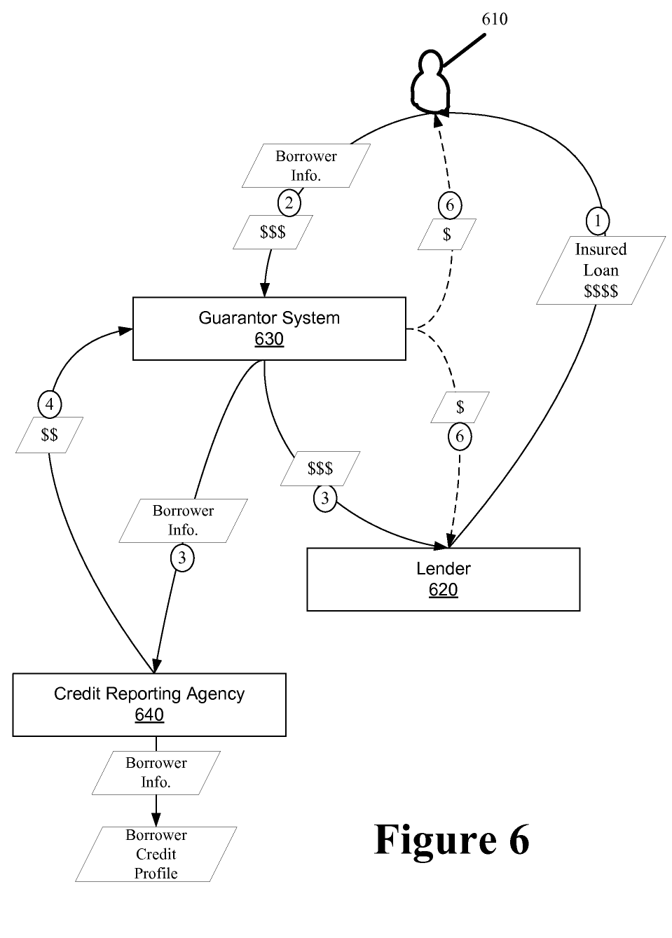

Credit reporting agencies value accurate payment history, trade reference, and other credit information, especially when the information is on difficult targets such as new and small businesses. As such, many credit reporting agencies are willing to pay to acquire such information. In some embodiments, the guarantor system resells the collected information to the various credit reporting agencies and uses the fees generated from reselling of the monitored information to offset or reduce the insurance premium charged to lenders and/or borrowers. Such a scenario is depicted in FIG. 6.

FIG. 6 illustrates interactions between a borrower 610, lender 620, the guarantor system of some embodiments 630, and a credit reporting agency 640. The lender 620 first originates a loan to the borrower 610 that the guarantor system 630 insures. The borrower 610 pays back the loan in installments with the guarantor system 630 monitoring the borrower 610 and collecting information about the borrower 610 over the duration of the loan. The collected information is sold for a fee to the credit reporting agency 640. The credit reporting agency 640 includes the collected information within a credit profile that it maintains on the borrower 610. The guarantor system 630 uses part of the fee to reduce the insurance premium or cost of the insurance policy guaranteeing the loan.

The guarantor system can also resell the collected information to different lenders. For instance, a first lender may extend a loan to a particular new business for which no prior information exists. The guarantor system monitors the performance of the particular new business under the terms of the loan. Thereafter, when the particular new business applies for a loan from a second lender, the guarantor system may sell the information collected on the particular new business to the second lender, thereby allowing the second lender to make a more informed decision on whether or not to lend to that particular new business.

To facilitate the information reselling, the guarantor system maintains its own repository comprising credit profiles for borrowers that are monitored or audited by the guarantor system. The credit profiles are populated with the information that the guarantor system collects during the monitoring or auditing of borrowers.

The information reselling described above therefore proves advantageous to all involved parties including the borrower, lender, guarantor system, and credit reporting agency. Borrowers benefit from being able to more easily obtain the capital they need because their loans are insured against default. Moreover, borrowers are encouraged to participate in the monitoring service as the collected information reduces the cost of loan acquisition by way of the subsidized premium. Lenders reduce their overall risk exposure as a result of the insurance coverage, monitoring service, and borrower collected information provided by the guarantor system. The guarantor system monetizes on the insurance coverage based on the insurance premiums. Additionally, the guarantor system is able to collect information on business that can be resold or used to better manage risk. Lastly, credit reporting agencies now have a new and essentially real-time data stream from which to obtain creditworthiness information that is usable in updating business credit profiles and assessing risk.

Many of the above-described guarantor system functionality and processes are implemented as software modules that are specified as a set of instructions recorded on a non-transitory computer readable storage medium (also referred to as computer readable medium). When these instructions are executed by one or more computational element(s) (such as processors or other computational elements like ASICs and FPGAs), they cause the computational element(s) to perform the actions indicated in the instructions. Server, computer, and computing machine are meant in their broadest sense, and can include any electronic device with a processor including cellular telephones, smartphones, portable digital assistants, tablet devices, laptops, notebooks, and desktop computers. Examples of computer readable media include, but are not limited to, CD-ROMs, flash drives, RAM chips, hard drives, EPROMs, etc.

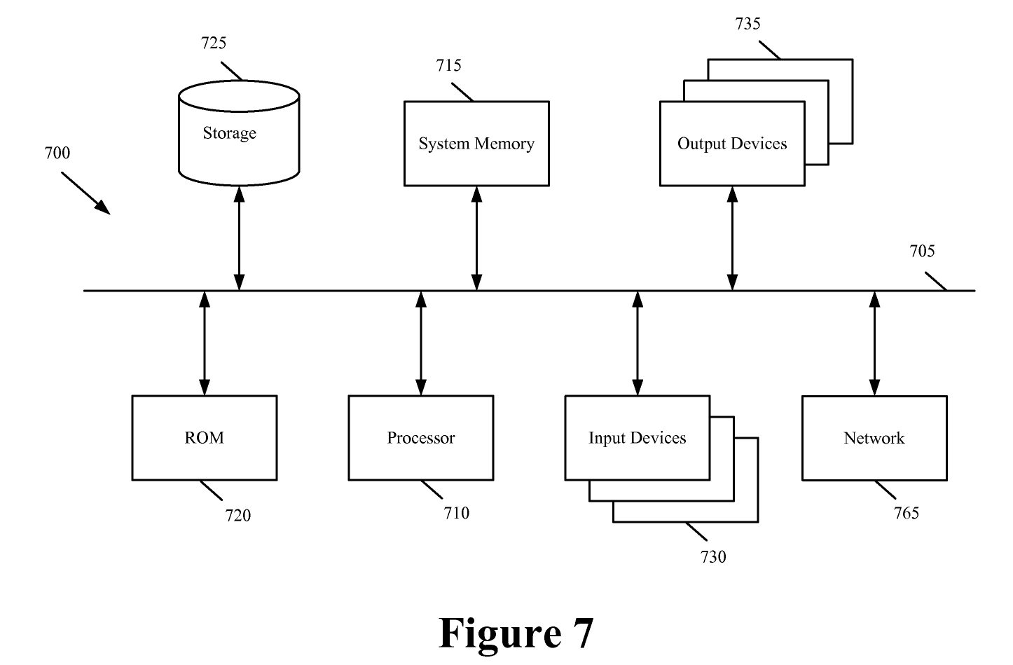

FIG. 7 illustrates a computer system or server with which some embodiments of the guarantor system are implemented. Computer system 700 includes a bus 705, a processor 710, a system memory 715, a read-only memory 720, a permanent storage device 725, input devices 730, and output devices 735.

The bus 705 collectively represents all system, peripheral, and chipset buses that communicatively connect the numerous internal devices of the computer system 700. For instance, the bus 705 communicatively connects the processor 710 with the read-only memory 720, the system memory 715, and the permanent storage device 725. From these various memory units, the processor 710 retrieves instructions to execute and data to process in order to execute the processes of the invention. The processor 710 is a processing device such as a central processing unit, integrated circuit, graphical processing unit, etc.

The read-only-memory (ROM) 720 stores static data and instructions that are needed by the processor 710 and other modules of the computer system. The permanent storage device 725, on the other hand, is a read-and-write memory device. This device is a non-volatile memory unit that stores instructions and data even when the computer system 700 is off. Some embodiments of the invention use a mass-storage device (such as a magnetic or optical disk and its corresponding disk drive) as the permanent storage device 725.

Other embodiments use a removable storage device (such as a flash drive) as the permanent storage device. Like the permanent storage device 725, the system memory 715 is a read-and-write memory device. However, unlike storage device 725, the system memory is a volatile read-and-write memory, such as random access memory (RAM). The system memory stores some of the instructions and data that the processor needs at runtime. In some embodiments, the processes are stored in the system memory 715, the permanent storage device 725, and/or the read-only memory 720.

The bus 705 also connects to the input and output devices 730 and 735. The input devices enable the user to communicate information and select commands to the computer system. The input devices 730 include alphanumeric keypads (including physical keyboards and touchscreen keyboards), pointing devices (also called “cursor control devices”). The input devices 730 also include audio input devices (e.g., microphones, MIDI musical instruments, etc.). The output devices 735 display images generated by the computer system. The output devices include printers and display devices, such as cathode ray tubes (CRT) or liquid crystal displays (LCD).

Finally, as shown in FIG. 7, bus 705 also couples computer 700 to a network 765 through a network adapter (not shown). In this manner, the computer can be a part of a network of computers (such as a local area network (“LAN”), a wide area network (“WAN”), or an Intranet, or a network of networks, such as the Internet.

As mentioned above, the computer system 700 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for reducing risk across a portfolio of loans issued by a lender to a plurality of borrowers, the method comprising:
performing a risk assessment of the lender that is independent of individual borrower default risk and that is further independent of individual loan default risk;
providing an insurance policy uniformly guaranteeing the portfolio of loans by guaranteeing at least some portion of each loan in the portfolio of loans based on the risk assessment of the lender, wherein said insurance policy applies to each loan in the portfolio of loans independent of different risks associated with each borrower of the plurality of borrowers and different risks associated with each loan in the portfolio of loans;
deriving a premium computation to apply across the portfolio of loans based on said risk assessment of the lender, wherein the premium computation provides a uniform premium amount that is chargeable for each borrowed dollar of a loan;
charging a premium to each loan in the portfolio of loans based on the premium computation and an amount of the loan, wherein the premium charged to each loan is determined independent of risk individually associated with a borrower of the loan and risk individually associated with the loan;
monitoring performance of a particular borrower in relation to a particular loan from the portfolio of loans issued to the particular borrower, wherein said monitoring comprises periodically contacting the particular borrower at different stages throughout pendency of the particular loan and obtaining information relating to creditworthiness of the particular borrower from the particular borrower at each of the different stages; and
offsetting an amount from the premium charged to the particular borrower for guaranteeing some portion of the particular loan by reselling the information relating to creditworthiness of the particular borrower to any of a lender and credit reporting agency.

2. The method of claim 1 further comprising receiving notice of default on a loan from the plurality of loans and providing payment to the lender for a portion of said loan that is guaranteed by the insurance policy.

3. The method of claim 1, wherein performing the risk assessment of the lender comprises measuring risk that is associated with a loan granting practice of the lender.

4. The method of claim 1, wherein performing the risk assessment of the lender comprises measuring total exposure to the lender from all loans in the portfolio of loans.

5. The method of claim 1 further comprising computing a first amount for the uniform premium amount when the risk assessment of the lender identifies a lower than average rate of loan default across the portfolio and a second amount for the uniform premium amount when the risk assessment of the lender identifies a higher than average rate of load default across the portfolio, wherein the first amount is less than the second amount.

6. The method of claim 1 further comprising selling the insurance policy to a third party guarantor, wherein the third party guarantor assumes obligations under the insurance policy to provide payment to the lender in event of loan default.

7. The method of claim 1 further comprising generating terms for the insurance policy that vary from initiation to termination of a loan, the terms comprising providing a first amount of coverage for a first duration of the loan and a second amount of coverage for a second duration of the loan.

8. The method of claim 7, wherein the first amount of coverage guarantees a greater portion of the loan than the second amount of coverage.

9. A guarantor system for reducing lender risk, the system comprising:
non-transitory computer-readable storage medium storing computer-executable instructions; and
a computer processor in communication with the non-transitory computer-readable storage medium, the computer-executable instructions from the non-transitory computer-readable storage medium programming the computer processor in:
performing a risk assessment of a lender based on total risk exposure to the lender from a plurality of loans issued by the lender;
determining, based on the risk assessment of the lender, a policy for guaranteeing at least some portion of each loan of the plurality of loans and a uniform premium amount that is chargeable for each borrowed dollar of a loan guaranteed by said policy;
providing a guarantee to a new loan issued by the lender to a particular borrower under said policy upon approval of a first loan application process conducted between the lender and the particular borrower, without the borrower conducting a second guarantee application process to separately apply for the guarantee with a guarantor;
computing an insurance premium for the new loan based on an amount of the new loan and the uniform premium amount that is chargeable for each borrowed dollar, and wherein computing the insurance premium is independent of the particular borrower's default risk;
assessing the insurance premium in return for guaranteeing the new loan; and
auditing the particular borrower during pendency of the new loan, wherein said auditing comprises contacting trade references engaged with the particular borrower during pendency of the new loan and quantifying risk of the particular borrower defaulting on the new loan based on information collected from the trade references.

10. The system of claim 9, wherein the policy insures a loan up to a first amount during a first term of the loan and up to a second amount during a second term of the loan, and wherein the first amount is greater than the second amount and the first term precedes the second term.

11. The system of claim 9, wherein the computer-executable instructions from the computer-readable non-transitory storage medium further program the computer processor in monitoring the new loan by notifying the particular borrower of upcoming payment due dates and by monitoring the particular borrower's payment history on the new loan during pendency of the new loan.

12. The system of claim 11, wherein the computer-executable instructions from the computer-readable non-transitory storage medium further program the computer processor in compiling updated information about financial performance of the particular borrower and changes to the particular borrower's business operations.

13. The system of claim 12, wherein the computer-executable instructions from the computer-readable non-transitory storage medium further program the computer processor in populating a credit profile for the particular borrower stored to the computer-readable non-transitory storage medium with the updated information.

14. The system of claim 12, wherein quantifying the risk of the particular borrower defaulting on the new loan is further based on any of said financial performance of the particular borrower and changes to the particular borrower's business operations.

15.-21. (canceled)

22. The method of claim 1, wherein obtaining information relating to creditworthiness of the particular borrower comprises obtaining information about any of financial performance and changes to the particular borrower's business operations.

23. The method of claim 1 further comprising auditing the particular borrower on behalf of the lender by quantifying risk of the particular borrower defaulting on the particular loan based on the information relating to creditworthiness of the particular borrower and by notifying the lender of said risk in advance of any default by the particular borrower.

24. The method of claim 1 further comprising populating a credit report of the particular borrower at a credit reporting agency with the information relating to creditworthiness of the particular borrower at each of the different stages.
